(19) United States
(12) Patent Application Publication
(10) Pub. No.: US 2003/0054831 A1
(43) Pub. Date: Mar. 20, 2003

(54) Intelligent receiver using GPS

(76) Inventor: Julia Bardmesser, Bethesda, MD (US)

Correspondence Address: Julia BARDMESSER, 10300 Thornbush Lane, Bethesda, MD, 20814, US

(21) Appl. No.: 09/953,959

(22) Filed: Sep. 18, 2001

(51) Int. Cl. H04Q 7/20; H04N 5/64

(52) U.S. Cl. 455/456; 348/837

(57) ABSTRACT

A radio receiver unit includes a GPS receiver, a processor for controlling a radio receiver and connected to the GPS receiver, wherein the processor tunes the radio receiver to a particular radio station based on positional information from the GPS receiver.

### BACKGROUND OF THE INVENTION

1. Field of the Invention

The present invention relates to radio receivers, and more particularly, to a radio receiver that automatically switches as the receiver moves, using GPS to identify its location and appropriate frequencies to tune to.

2. Discussion of the Related Art

Modern radio receivers, such as those commonly found in cars, have a number of preset stations that a listener can manually preset in order to avoid the inconvenience of having to scan the frequencies every time the listener wishes to change stations. Most people typically listen to only a few stations, for example, rock and news stations. However, as the listener's car moves from one location to another, the stations with which the use is familiar move out of range. Thus, a user whose music tastes involve, for example, country music, would have to search through the available stations when his car reaches a new city. This process may be inconvenient, particularly as the user continues to drive from city to city. Accordingly, a system is desirable that would avoid the inconvenience of having to search and pre-set available radio stations, where a user can automatically have the radio receiver switched to a station similar to that he or she had been listening to.

### SUMMARY OF THE INVENTION

Accordingly, the present invention is directed to an intelligent receiver using GPS that substantially obviates one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, in one aspect of the present invention there is provided a radio receiver unit comprising a GPS receiver, a processor for controlling a radio receiver and connected to the GPS receiver, wherein the processor tunes the radio receiver to a particular radio station based on positional information from the GPS receiver.

In another aspect of the present invention there is provided a mobile television comprising a GPS receiver, a processor for controlling a television receiver and connected to the GPS receiver, wherein the processor tunes the television receiver to a particular radio station based on positional information from the GPS receiver.

In another aspect of the present invention there is provided a radio receiver unit comprising a processor for controlling a radio receiver, a database of radio stations, identifying broadcast frequencies and types of the radio stations by geographic region, wherein the processor tunes the radio receiver to a particular radio station based on current geographic position of the radio receiver and the database.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram showing an overview of the system of the present invention.

### DETAILED DESCRIPTION OF THE PREFERRED EMBODIMENT

Reference will now be made in detail to the preferred embodiments of the present invention, examples of which are illustrated in the accompanying figures.

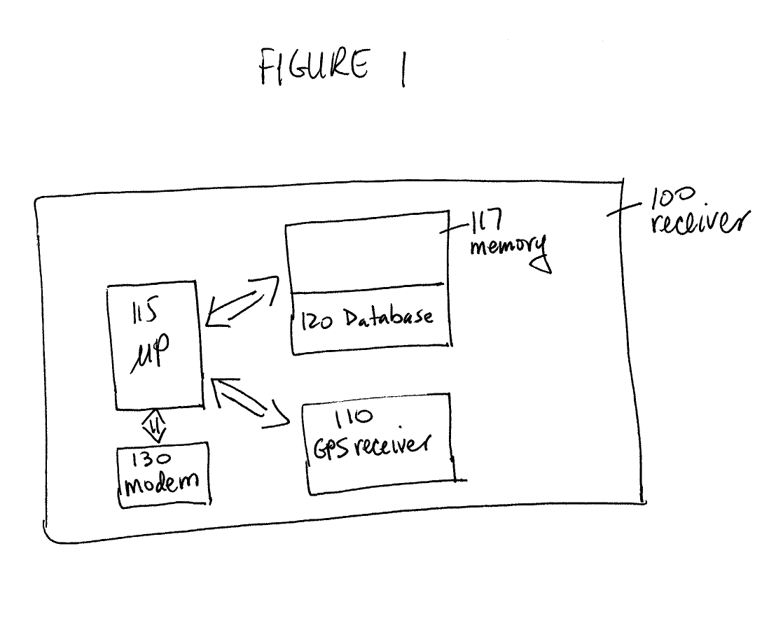

As shown in FIG. 1, the radio receiver 100 of the present invention includes a GPS receiver 110 for calculating the present position of the radio receiver 100. The radio receiver 100 also includes a microprocessor 115 and a memory that can include a database 120. One way to arrange the database 120 is to divide the country (for example, the United States) into a grid, and each “square” in the grid will have associated with it radio stations that operate in that square of the grid. Additionally, each radio station within a particular square of the grid may have another attribute, that identifies the type of that radio station (e.g., rock, country, classical, news, etc.). Thus, as the radio receiver 100 moves from one square of the grid to another square, the microprocessor 115 periodically receives information from the GPS receiver 110 about its current geographic position (for example, either by querying the GPS receiver 110, or by interrupts from the GPS receiver 110 on a periodic basis), and when the current position changes from one square to a different square, the microprocessor 115 will access the database 120 to identify which radio stations are operating in the current square. Additionally, with instructions from the user for which type of radio station the user prefers to listen to, the microprocessor 115 will automatically tune to the radio station in the new square that fits the user's preferences (e.g., listening to National Public Radio or NPR, while the car is moving along a highway). Another option is, with knowledge of the type of station that the receiver 100 is currently tuned to, as the receiver 100 moves to a different area, the microprocessor 115 would identify a corresponding station in the new area, and tune to that station.

Although the above description is formulated in terms of a grid, it is readily understood that it is not necessary to divide the country into squares. To the extent it is more convenient (or technically appropriate), the country may be divided into regions that more closely correspond to, for example, cities and rural areas. Thus, it may be more practical to divide the country into, for example 200 cities and the areas follow the major highways, rather than simply allocate memory and database space to regions of the country where, as a matter of practical experience, the radio receiver 100 is unlikely to find itself, e.g., rural areas.

Additionally, it is expected that the frequencies on which the radio stations in any particular city operate and the type of music that a particular radio station plays may change over time. Thus, there may be a need to update the database 120 periodically, for example, once a month or once every several months. Therefore, although the database 120 is expected to be stored on a memory chip, it may also be updated periodically. One option is to provide the user the option to swap one memory chip or card for another. Another option is to periodically broadcast the changes to the database 120 on a predetermined frequency. The receiver 100, knowing which frequency to listen to, and knowing what time to listen to (e.g., 12 a.m. on the 1^{st} of every month) would update its database 120 accordingly.

Yet another option is for the radio receiver 100 to access an up-to-date database 120 over a cellular telephone link or a cellular modem 130. The radio receiver 100 would thus download the latest database from a website, whenever the user desires or on a preprogrammed interval (for example, once a month).

It will be appreciated by one of ordinary skill in the art that the invention described herein is applicable to not only radios but also to television receivers. Thus, a television receiver that moves from area to area and can remain tuned to the same television station, for example NBC, or CBS.

It will also be appreciated that the radio receiver 100 of the present invention need not be mounted on a car. It can also be mounted on a train, or aircraft, or ship, or any other moving chassis. The system of the present invention can even be incorporated into a portable radio, if desired.

Furthermore, the system of the present invention is applicable to other applications involving moving vehicles and GPS. For example, instead of (or in addition to) the radio stations, the database can include information about speed limits that are applicable to a particular stretch of road. As the car moves, this information can be displayed (either on the radio, or on a heads-up display). An engine control system can be tied to the output of the microprocessor 115, and prevent the driver from exceeding the speed limit (for example, for trucks).

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A radio receiver unit comprising:
a GPS receiver;
a processor for controlling a radio receiver and connected to the GPS receiver;
wherein the processor tunes the radio receiver to a particular radio station based on positional information from the GPS receiver.

2. The radio receiver unit of claim 1, further including a database of radio stations, identifying broadcast frequencies and types of the radio stations by geographic region.

3. The radio receiver unit of claim 2, wherein the processor tunes the radio receiver to a station based on the types of the radio stations information in the database.

4. The radio receiver unit of claim 2, wherein the database is updated over a cellular modem link.

5. The radio receiver unit of claim 2, wherein the database is updated by receiving broadcast information.

6. The radio receiver unit of claim 1, wherein the radio receiver is mounted in a car.

7. The radio receiver unit of claim 1, wherein the radio receiver is portable.

8. A mobile television comprising:
a GPS receiver;
a processor for controlling a television receiver and connected to the GPS receiver;
wherein the processor tunes the television receiver to a particular radio station based on positional information from the GPS receiver.

9. The television receiver of claim 8, further including a database of television stations, identifying broadcast frequencies and types of the television stations by geographic region.

10. The television receiver of claim 9, wherein the processor tunes the television receiver to a station based on the types of the television stations information in the database.

11. The television receiver of claim 9, wherein the database is updated over a cellular modem link.

12. The television receiver of claim 9, wherein the database is updated by receiving broadcast information.

13. The television receiver of claim 8, wherein the radio receiver is mounted in a car.

14. The television receiver of claim 8, wherein the radio receiver is portable.

15. A radio receiver unit comprising:
a processor for controlling a radio receiver;
a database of radio stations, identifying broadcast frequencies and types of the radio stations by geographic region;
wherein the processor tunes the radio receiver to a particular radio station based on current geographic position of the radio receiver and the database.

16. The radio receiver unit of claim 15, wherein the database is updated over a cellular modem link.

17. The radio receiver unit of claim 15, wherein the database is updated by receiving broadcast information.

18. The radio receiver unit of claim 15, wherein the radio receiver is mounted in a car.

19. The radio receiver unit of claim 15, wherein the radio receiver is portable.

20. The radio receiver unit of claim 15, wherein the processor receives the current geographic position from GPS receiver.
